(19) United States
(12) Patent Application Publication
(10) Pub. No.: US 2012/0129144 A1
(43) Pub. Date: May 24, 2012

(54) Computer Aided Apparatus and Method of Learning

(76) Inventor: Prabind Kumar Singh, Guwahati (IN)

(21) Appl. No.: 13/114,296

(22) Filed: May 24, 2011

Related U.S. Application Data
(60) Provisional application No. 61/348,745, filed on May 27, 2010.

(51) Int. Cl. G09B 5/00

(52) U.S. Cl. 434/322

(57) ABSTRACT

A learning device for students of all classes consisting of a virtual tutor. It comprises of hardware and software system with inbuilt internet. The tutor application is a software instructions executed in the central processing unit that reads the course contents stored in the hardware storage and gives the audio visual output to the learner. The device acts as an educational tool and provides assistance for assimilating the subject material. The device or system consists of inbuilt internet facility with internet browser and tracks user's activities. The user's activities get analyzed and user's profiling is generated for records and sent to parents. The device or system consists of search filter to prevent accessing of foul or irrelevant contents. Attachable Solar panels help operate the device when there is no electricity or in rural and remote regions where there is no electricity.

### CROSS REFERENCE TO RELATED APPLICATIONS

This application claims the benefit of U.S. Provisional Patent Application No. 61/348,745 filed on May 26, 2010, which is herein incorporated by reference in its entirety for all purposes.

### FIELD OF THE INVENTION

Methods and apparatuses consistent with the invention relate to a cloud based interactive learning device which helps students to easily comprehend and understand graphical and pictorial learning material designed in the form of video and animation that may be replayed anytime for the student's learning convenience. According to an aspect of the invention, students will have access to learning material that is hosted online in the form of sessions, and will have access to expert tutors to clarify their doubts.

### BACKGROUND OF THE INVENTION

Education has been considered the main contributing factor in the growth of children. However, most educational systems follow a traditional method of teaching and learning, where the main focus of the student is to attend class or lectures, take and read notes, and then take an examination at the end of the year. In this traditional method, as soon as the student leaves the classroom, he is left with only an option of reviewing the teacher's notes if the student needs to understand the concepts or clarify any doubts. Such notes may not necessarily be complete or correct.

Teachers and educators have always faced the challenge of getting the required attention of the student in the classroom. The challenge of creating an environment wherein the student is motivated to learn and understand the concepts him or herself rather than just read and later recite material without a full understanding has haunted teachers and even parents. However, with advances in the field of technology and the ease with which the younger generation adapts and understands such technology, the educational system has seen tremendous change and development. The educational system is evolving with the changing world of technology and innovation. Now teachers and educators do not go through several rows of books on shelves in libraries and book stores to find relevant reference books and notes, they just go online and search for the related topic and books for class notes or other research work. Same goes with students of all levels. However, there remains the issue of determining what is good or bad for the student. Even if the student wants to prepare for a project there is a vast sea of information available over the internet but the ability to filter the right content is still missing. Students struggle to find the right help at right time. Hundreds of applications and access to the sea of information creates a challenge for all—teachers, parents and student—first for the student to filter out what is needed and what's not and then for the parents/teachers to keep a vigil on the student's online activity and save them from explicit, illegal and incorrect information available to the student at a very young age.

With access to the world of technology and internet the entire educational system has been re-defined. There is instant access to the sea of knowledge spread across the network wireframes set on servers in different countries and continents. Education now crosses boundaries, and cultures. Focus of education has changed from being book centric to knowledge centric. Educational systems throughout the world are turning towards using blended form of learning as significant method for sharing knowledge and building skill levels amongst the students.

The concept of virtual classrooms, use of e-learning content for better understanding have been available but no one has ever created a product or a solution which grants access to knowledge and information that is required for the healthy growth of a student's brain and psychology and still filter out the unnecessary content and protect the impressionable minds from being exploited.

According to an exemplary embodiment, the present invention is like a laptop that act as books providing e-learning material, through electronic content software. The device runs its own operating system (OS), and acts as a virtual tutor. The device is equipped to tutor students preparing for high school certification exams, but this cloud based device is versatile enough for its use to be diversified. This device has e-learning content through embedded software, and is based on artificial intelligence and is accompanied by a digital pen which allows instant give and take between the students and tutors. The cloud based device allows 24-hour internet connectivity. The parental control can provide breakdown of the user's hours, enabling parents to monitor their children.

### SUMMARY OF THE INVENTION

This invention offers the best customized virtual classroom access to allow the student to develop a pace of study and the flexibility of time and place. It is a personal enhancement tool which amalgamates online curriculum and assessments with various creative programs of study, educational gaming, and online courseware for students. Its extensive e-learning material includes animations and videos which make learning an amicable experience.

An object of the invention is to overcome at least some of the drawbacks relating to the current education system and enhance the method of learning and teaching through the use of software and hardware integration.

Hence, the invention consists of a complete hardware integration for educational purpose comprising of a central processing unit, a storage media, inbuilt network data card and an output device such as a screen. The network card is able to access the Internet through the use of inbuilt browser.

This invention is based on the Device Based e-Siksha Model (DBSM) technology. The word is siksha from the Sanskrit language meaning “learning”. It is a complete 360 degree solution for the education of the child. The entire gamut of hardware, software, application and the content platform along with the High Speed Internet Access (HSIA) connectivity form the basis of DBSM.

The configuration consists of learning software executing in the central processing unit. The software consists of a media player reading course content with its output being displayed in an audio visual format.

In other aspects, the invention provides a system and a computer program having features and advantages for the improvement and advancement in the field of learning and teaching.

### BRIEF DESCRIPTION OF THE DRAWINGS

Having thus described the invention in general terms, reference will now be made to the accompanying exemplary drawings, which are not necessarily drawn to scale, and wherein:

FIG. 1 illustrates an exemplary embodiment of the hardware integrated DBSM.

FIG. 2 illustrates an exemplary embodiment of the Parental Control System (PCS).

FIG. 3 illustrates an exemplary embodiment of the Titli browser.

FIG. 4 illustrates an alternative exemplary embodiment of the Titli browser.

FIG. 5 illustrates an exemplary embodiment of components within the Titli browser.

FIG. 6 illustrates an exemplary embodiment of the Tutor application.

FIG. 7 illustrates an exemplary embodiment of the Games application.

FIG. 8 illustrates an exemplary embodiment of the layered architecture of the DBSM.

FIG. 9 illustrates an exemplary embodiment of the EBtube application.

FIG. 10 illustrates an exemplary embodiment of the output display generated by the DBSM.

### DETAILED DESCRIPTION OF THE INVENTION

An exemplary embodiment of the DBSM consists of complete hardware and software integration for increased ease of use.

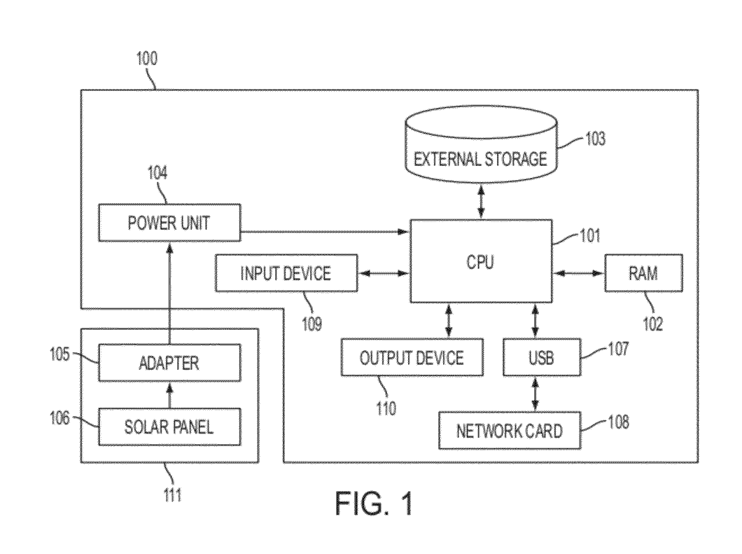

The hardware integration differs from traditional methods in that the integration emphasizes mobility and ease of use for children. Referring to FIG. 1, the hardware integrated module 100 includes a CPU unit 101 for processing instructions, RAM memory 102 for temporary and fast storage, External Storage 103 for slower but larger storage capacity, a Power Unit 104 for supplying the device with power, an Input Device 109 allowing for external input into the device by a user (such as typing, mouse movement, etc.), an Output Device 110 for displaying or otherwise communicating information to a user, a USB port 107 allowing for the addition of any USB compatible device such as the Network Card 108 for providing the device with network access, such as to the internet. The Network Card 108 may provide network access via wired or wireless means. Additionally, if a traditional power source is unavailable for the Power Unit 104, an alternative power source module 111 may be provided which includes a Solar Panel 106 in combination with an Adapter 105 to provide solar power to the Power Unit 104. The Solar Panel 106 and Adapter 105 are specifically designed for developing nations where electricity is not universally available nor secure. The Solar Panel 106 and Adapter 105 stores up to 5 hours worth of energy for the device for use in such conditions. The device 100 and 111 is purposefully made lightweight for use by young school age children, and may weigh less than one kilogram combined weight.

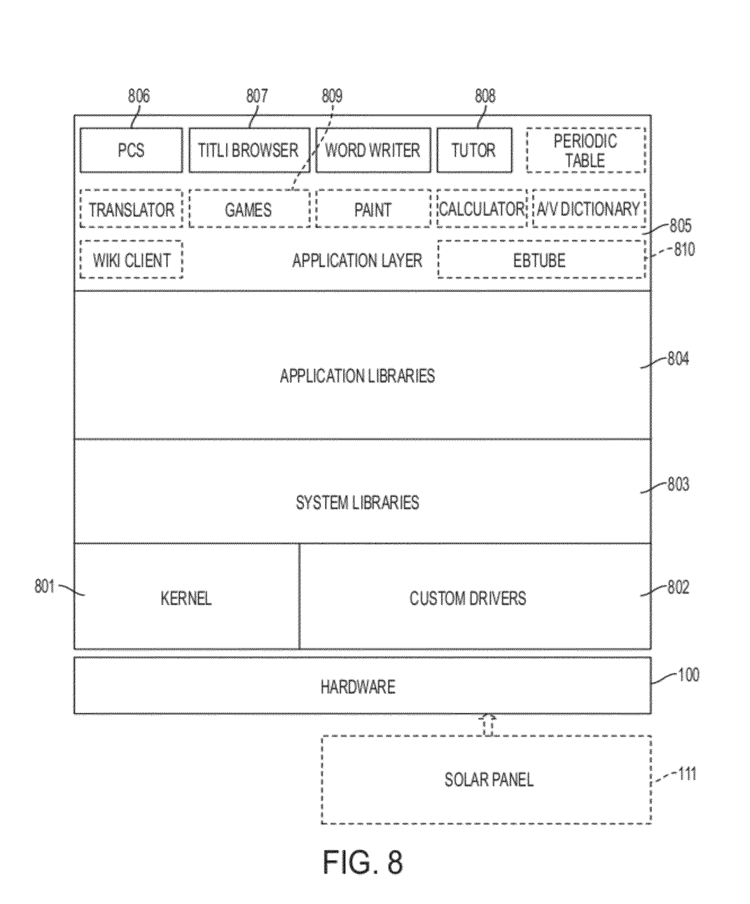

The software integration is illustrated in FIG. 8, and is a layered architecture. On top of the hardware module 100, sits an operating system kernel 801, and custom drivers 802, which are specific to the hardware module 100. On top of the kernel are system libraries 803, and then application libraries 804. The top most layer is the application layer 805, consisting of the PCS 806, which stands for parental (or guardian) control system, the Titli browser 807 (“Titli” is a Hindi word meaning butterfly), Tutor application 808, and Games application 809.

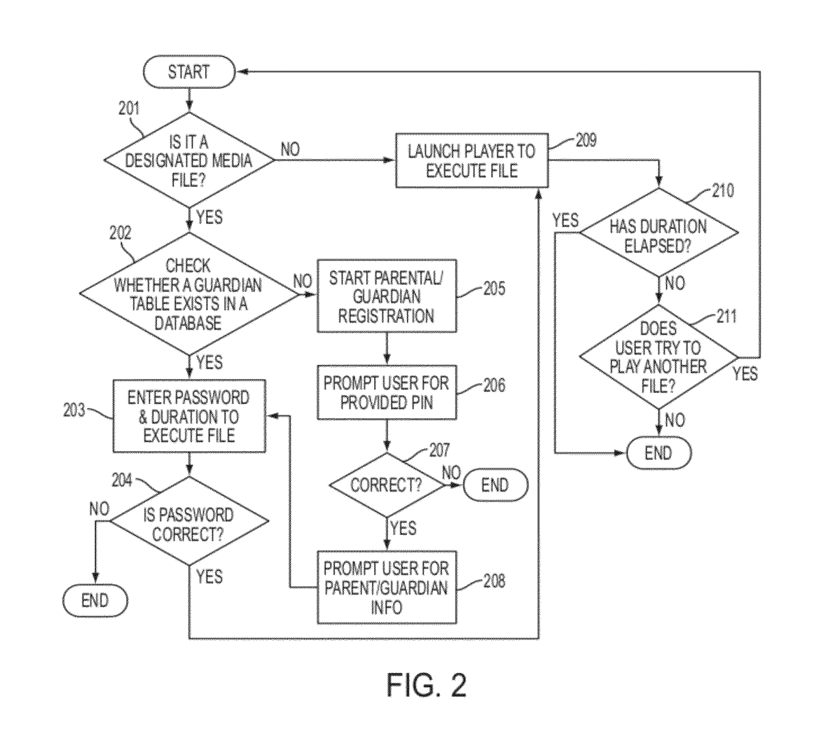

The PCS 806 is implemented through a secondary registration process for the parent illustrated in FIG. 2, separate from a registration process for the student. When a user attempts to execute a media file for consumption, step 201 determines whether the media file is a designated media file subject to restrictions. Media files may be designated as subject to restrictions based on an individual file by file basis or as group such as restricting all video files, for example. If the media file is not a designated media file, the appropriate player is launched to execute the file in step 209. If it is not a designated media file then no duration restriction is set, and it will always proceed past step 210 to step 211 where if, after or during the consumption of the media file, the user attempts to execute another media, the player exits and returns to the start to determine whether that media file is subject to restrictions.

If in step 201 it is determined that the media file is a designated media file, then the system checks whether a guardian table exists in a database in step 202. If the table exists, in step 202 a prompt is displayed in step 203 for entry of the guardian password and a duration that the user is authorized to consume the media file. Then in step 204, the authenticity of the guardian password is verified. Only if the password is correct will a player launch in step 209 to execute the media file. Since the media is a designated media, step 210 determines whether the entered duration has expired. If it expired, the process ends. If it has not expired it proceeds to step 211 where if, after or during the consumption of the media file, the user attempts to execute another media, the player exits and returns to the start to determine whether that media file is subject to restrictions.

If in step 205, it is determined that the table does not exist, the parental/guardian registration process is started in step 205. In step 206, a prompt is displayed for entry of a PIN provided with the purchase of the device. If the provided PIN is incorrect in step 207 then the process ends. If the provided PIN is correct in step 207, a prompt is displayed in step 208 for the parent/guardian information. Upon confirmation of this information, the process returns to step 203.

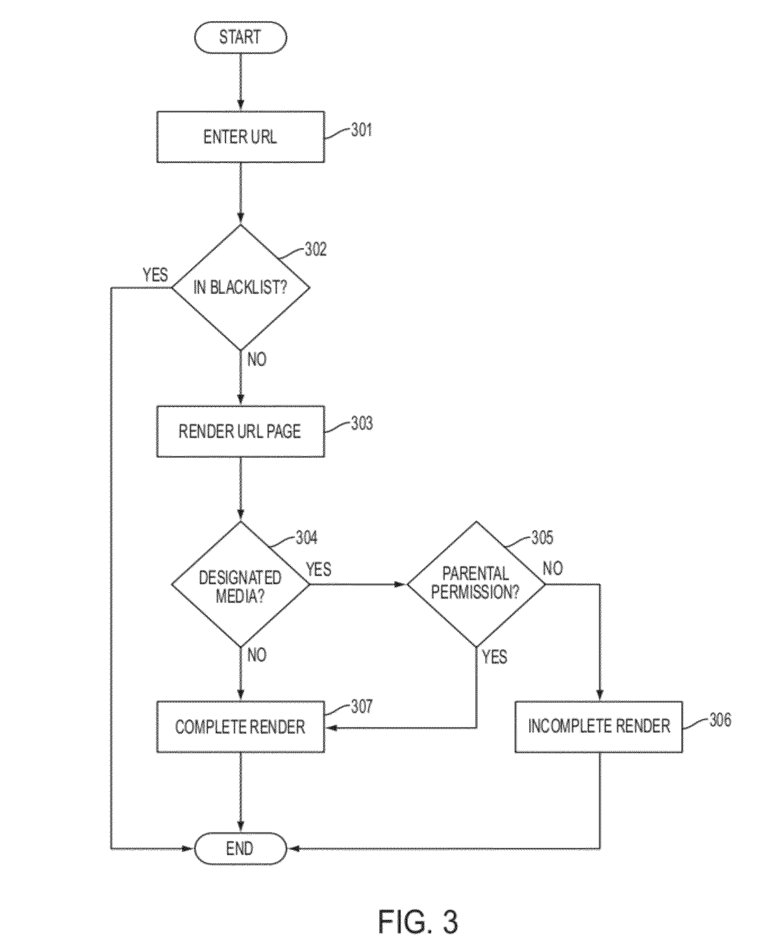

The Titli Browser 806 is implemented as a traditional web browser but with added features targeted toward parental/guardian control of a user's activities. As the PCS was illustrated with respect to designated media in FIG. 2, the PCS is similarly implemented within the Titli Browser 806. As illustrated in FIG. 3, when a URL is entered in to the browser in step 301, it proceeds to step 302 to determine whether the URL is blacklisted. The parent or guardian can access and edit the blacklist as appropriate by a adding or removing a URL from the list. If the URL is blacklisted, the process ends and the URL is not rendered. If the URL is not blacklisted, in step 303, the browser proceeds to step 303 to render the page. In step 304, while rendering, the browser determines that the page contains designated media, it prompts for parental or guardian authorization in step 305. If authorization is provided, the URL page is completely rendered in step 307 including the designated media. If the authorization in step 305 is not provided, then the browser will perform an incomplete render in step 306 where the designated media is not rendered, but the remainder of the page is.

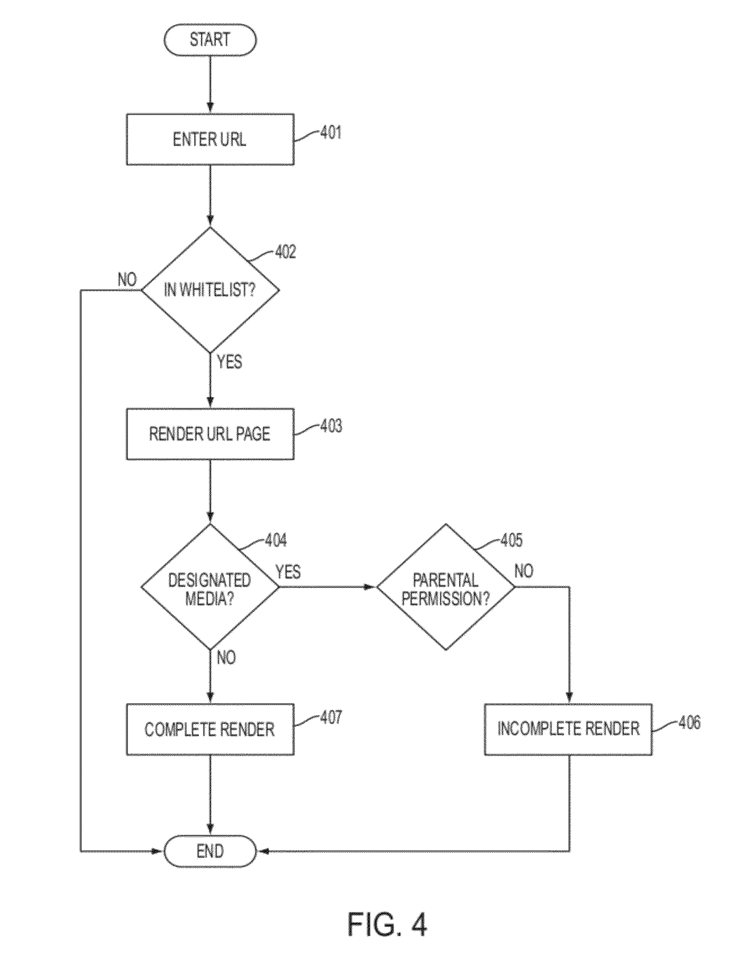

FIG. 4 illustrates an alternative embodiment of the Titli Browser 806 identical to FIG. 3 except in step 402. In step 402, the browser utilizes a whitelist as opposed to a blacklist in step 302 of FIG. 3. If the URL is determined not to be in the whitelist, the process ends, otherwise if the URL is whitelisted, the process proceeds to step 403 to render the URL page.

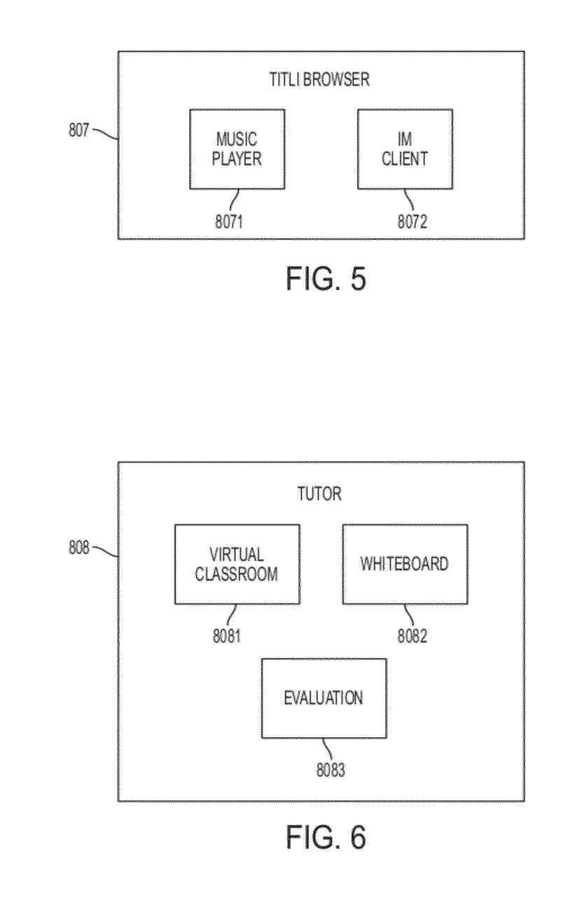

FIG. 5 illustrates additional components within the Titli Browser 807. The Titli Browser 807 includes a built-in music player 8071 and Instant Messaging (IM) client 8072. The built-in music player 8071 allows the playback of music within the Titli browser 806. The IM client 8072 provides interactivity among the user's peer group by using system registration data to create a global classroom village of same class students and allow them to coordinate and share their knowledge.

FIG. 6 illustrates the Tutor application 808, which consists of a Virtual Classroom 8081, a Whiteboard 8082, and Evaluation module 8083. The Virtual Classroom 8081 allows a user access to a tutor at any given point in time. The relationship between the user and tutor may be one-to-one, or one-to-many. The one-to-many relationship occurs when multiple users each with their own DBSM are accessing the same tutor. If the device is equipped with a visual and audio input device, such as a webcam, the user may see and speak directly with the tutor, or otherwise the user may communicate via text. The Virtual Classroom 8081 allows the student to, for example, ask questions and seek explanations from someone familiar with the subject matter during the learning process. The Whiteboard 8082 provides a common area where both the user and tutor can read from and write to, for increased collaboration. The Evaluation module 8083 allows a user to evaluate each tutor, so that tutor who receives a low evaluation will not be reassigned, ensuring that only tutors who received high evaluations are assigned to help the user. The evaluation for the tutor may be based on each individual user's given evaluations, or an average of all given evaluations for a particular tutor.

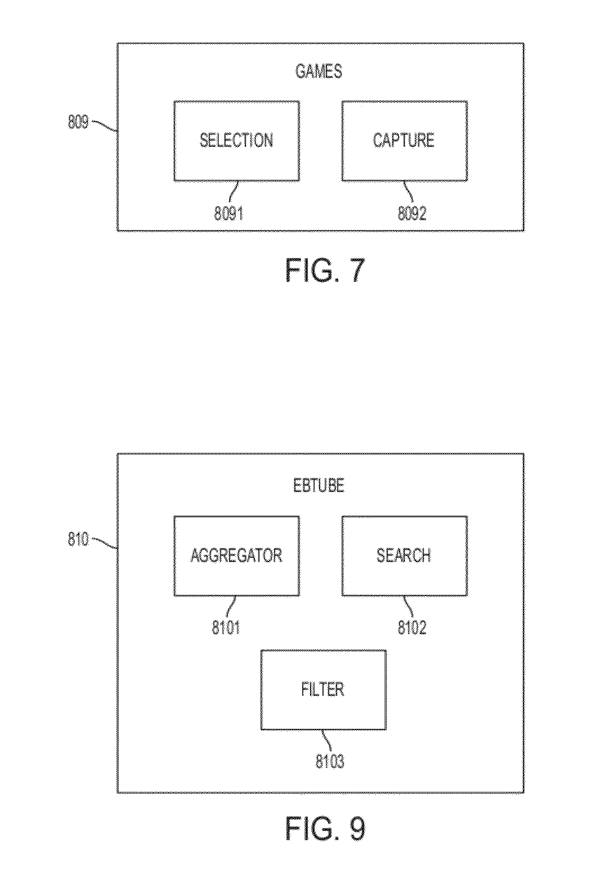

FIG. 7 illustrates the Games application 809. Typically the Games application 809 provides educational games to the user selected on the basis of the user's age and educational level via Selection module 8091. When a user plays a game, their usage pattern is captured via Capture module 8092 and provided to the parent/guardian.

FIG. 9 illustrates the EBtube application 810. The EBtube application 810 can display video aggregated from multiple sources via the Aggregator 8101, such as Google Video, YouTube, and the iBerry network. A search module 8102 allows the user to search for content, and Filter module 8103 filters the content based upon parent/guardian preferences.

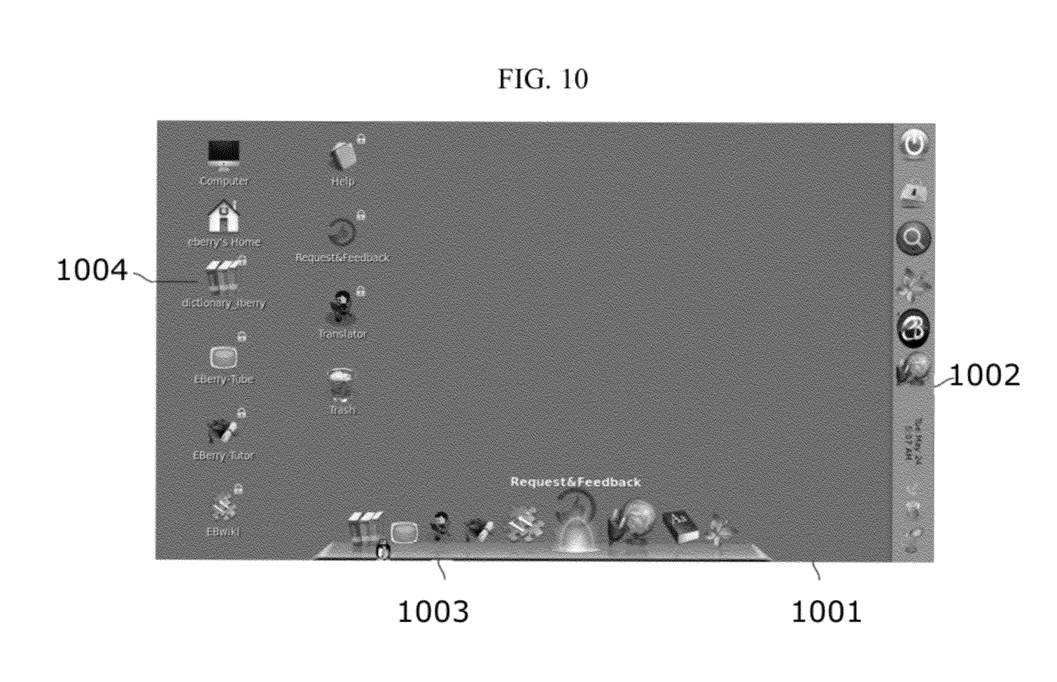

FIG. 10 illustrates an example display that may be output to a screen by Output Device 110. The display includes a desktop 1001, a Side Panel 1002, an Application Dock 1003, and icons such as Icon 1004. Both the Side Panel 1002 and Application Dock 1003 may slide away from the screen and become hidden, whereupon they reappear when a user moves a mouse cursor to the side of the screen on which they are hidden, respectively. The display makes maximum use of the space available by hiding the Side Panel 1002 and Application Dock 1003 when they are not in use. The location of the Side Panel 1002 and Application Dock 1003 are determined in accordance with Fitt's law which states that access time is dependent upon two things: 1) the size of the target, and 2) the distance of the target.

What is claimed is:

1. A method for providing a learning environment for a student, the method comprising:
restricting the student's access to designated media through a parental control system,
providing the student access to a tutor at the convenience of the student, and
filtering the student's access to locations and media on a network.

2. The method of claim 1, wherein restricting the student's access comprises:
designating media files as requiring parental control,
prompting for a parent password and duration if the designated media is executed by the student,
verifying the parent password,
allowing the student access to the designated media executed by the student only upon successful verification and only for the duration specified.

3. The method of claim 1, wherein providing the student access to the tutor comprises:
providing the access on a one-to-one basis or on a one-to-many basis.

4. The method of claim 1, further comprising:
allowing the student to provide feedback on the tutor, and
selecting a subsequent tutor on the basis of the feedback.

5. The method of claim 1, wherein filtering the student's access on the network comprises:
requiring parental permission to access the media on the network if it is designated media.

6. The method of claim 1, wherein filtering the student's access on the network comprises:
filtering the access based on a whitelist or a blacklist of permitted content.

7. The method of claim 1, further comprising:
recording a log of the student's activities, and providing the log to a parent or guardian.

8. A set of instructions, embodied on a computer readable medium, which when executed:
restrict the student's access to designated media through a parental control system,
provide the student access to a tutor at the convenience of the student, and
filter the student's access to locations and media on a network.

9. The set of instructions of claim 8, wherein restricting the student's access comprises:
designating media files as requiring parental control,
prompting for a parent password and duration if the designated media is executed by the student,
verifying the parent password,
allowing the student access to the designated media executed by the student only upon successful verification and only for the duration specified.

10. The set of instructions of claim 8, wherein providing the student access to the tutor comprises:
providing the access on a one-to-one basis or on a one-to-many basis.

11. The set of instructions of claim 8, further comprising:
allowing the student to provide feedback on the tutor, and
selecting a subsequent tutor on the basis of the feedback.

12. The set of instructions of claim 8, wherein filtering the student's access on the network comprises:
requiring parental permission to access the media on the network if it is designated media.

13. The set of instructions of claim 8, wherein filtering the student's access on the network comprises:
filtering the access based on a whitelist or a blacklist of permitted content.

14. The set of instructions of claim 8, further comprising instructions which:
record a log of the student's activities, and provide the log to a parent or guardian.

15. A device for providing a learning environment for a student, the device comprising:
a CPU for processes instructions given to the device,
an network card connected to the CPU for providing network access, and
a solar panel connected to the CPU for providing power to the device.
